(19) United States
(12) Patent Application Publication
(10) Pub. No.: US 2009/0021349 A1
(43) Pub. Date: Jan. 22, 2009

(54) Method to record and authenticate a participant's biometric identification of an event via a network

(76) Inventors: Stephen Errico, Charlotte, NC (US); Steven Pfrenzinger, Palm Desert, CA (US)

Correspondence Address: CLEMENTS BERNARD MILLER, 1901 ROXBOROUGH ROAD, SUITE 300, CHARLOTTE, NC, 28211, US

(21) Appl. No.: 11/880,017

(22) Filed: Jul. 19, 2007

(51) Int. Cl. G06F 7/04

(52) U.S. Cl. 340/5.82

(57) ABSTRACT

The current invention is a method to improve the integrity or identification theft of content, such as emails, websites, and software, for example, by revealing the identity of the participant. In particular, the method ensures the participant's identity by requiring biometric input unique to the participant, creating a program which converts the biometric information into a unique identifier, for example, and incorporating the unique identifier into content, such as the software, emails, websites, etc. for future reliability. The present invention allows users to know that the participant's identification be biometrically confirmed, if necessary.

### BACKGROUND OF THE INVENTION

1. Field of the Invention

Due to increasing security and authentication requirements, identity theft and expanded use of online access to information and financial assets, Bio-Stamp is a proprietary process that records and authenticates biometric information about a participant's identity when he or she requires an action on a network at a point in time, collectively referred to as a network event. A user (a company, for example) of Bio-Stamp's processes can require that a network event participant's biometric information be recorded, for example, by capturing a fingerprint, before being allowed (authorized) to take some action that requires such recordation. If the participant has previously registered in Bio-Stamp's worldwide database, or registers during the event, as authorized, a registered participant's identity can be biometrically validated (revealed) to the user with, for example, a retina scan before being allowed (authorized) to take some action that requires such validation.

These events on a network include the following examples where a user (a company, for example) of Bio-Stamp's processes wants to record or authenticate a participant's identification at the point of: entering a building, signing on to a system, initiating a financial transaction, purchasing and receiving goods, sending an e-mail, posting content on the internet, reviewing posted content on the internet, validating ownership of intellectual property in a digital format, or confirming a participant being present at a specific location on a specific date and time, for example. Many other network events may also require using Bio-Stamp's database.

Bio-Stamp will also create and provide a unique identifier from/with related biometric information to act as a record for the event record processing of a unique network event, which can be used for many purposes. These purposes may include but are not limited to the following examples, which can benefit both the user and the participant: a log (history) record of the network events to document the occurrence, a message to the registered participant to alert them that their identity has been required, or a marker physically inserted or recorded into content which has been sent or posted via the internet, in association with a specific person.

This marking/recording, as a network event, can also be employed after initial registration or authentication to provide the user/company access to the worldwide database to repeatedly reveal/authenticate, identify or contact the specific person, or optionally review the biometric information of a specific person. Examples of this usage include: identifying the participant of an event at the point a user/company encounters the participant on the internet; validating and authenticating a customer-participant of a financial transaction; validate the presence of a specific person at a specific location; or any other subsequent need to reveal, identify or even contact the specific person associated with a network event. The combined methods and components act as an information or service bureau for internet identity and authentication.

2. Prior Art

Users of computer programs, email, software and internet websites recognize and want to avoid identify theft, fraudulent content and want to have the ability to have their participant's identity verified. If the participant's identity is not verifiable then users (parties or systems) risk acting on false pretense, which makes it easy for those who are unethical and less scrupulous to cause harm.

Current methods and inventions have addressed the problem but fall short. Public key infrastructure (otherwise known as PKI) and single socket layer (otherwise known as SSL) are an encryption, decryption process or are authentication procedures and protocols designed to produce security-based programs, for example to send top secret data and other information through the internet. Such a process is complex and costly to implement and its focus is on securing the content from unauthorized users. It does not allow a bank to verify the identity of a customer who requested a large sum of money be transferred out of his/her account and into another account, for example. It does not allow a business consulting firm to verify the identity of third parties working on a confidential merger or acquisition. Often the need exists to be able to promptly verify that important communications were sent by the authorized party.

Other companies have website certifications and seals of approvals such as VeriSign® and WebTrust®. Such companies attempt to provide the user with confidence that a particular web company has met predetermined standards and that such companies display the logo seal indicating that the site or software has met such standards. Such methods have improved the confidence in internet commerce such as Paypal® by providing consumer confidence in using credit cards when buying products through the internet. However, this type of verification does not adequately identify the participant. Other password type methods are used to confirm the identity of the party at time of sign-on but those methods fail to directly connect the message/request/email to the party.

Where stealing a credit card or someone's social security number gives the crook the ability to assume the identity of someone else, the present invention has the ability to counter that by biometrically authenticating that this is the person authorized to conduct this transaction or process. The present invention also has the ability to provide greater confidence that important interactions are with the intended party or parties, or to verify that a specific person was present at a specific time and place.

### SUMMARY OF THE INVENTION

Bio-Stamp is a proprietary concept that provides a company with tools (software components) that biometrically authenticates a participant's identity for an event on the internet or on a network. An event on an internet or network may be entering a building, signing on to a system, initiating a financial transaction, sending an e-mail, posting content on or through the internet, or confirming being present at a specific location at a specific date and time. Thus the present invention is a method to provide verification of integrity of an event by revealing the identity of the participant. In particular, the method ensures the participant's identity by requiring biometric input unique to the participant provider, creating a program which converts the biometric information into a unique identifier such as a number, for example, and incorporating or recording the unique identifier into content such as programs, emails, documents, software, websites, etc. for future reliability. The present invention allows users (such as companies) of Bio-Stamp to know the identification of those participants who wish to employ the user's network or internet access. The user incorporates Bio-Stamp into the user's network or internet access so that the Bio-Stamp™ system of the present invention can identify the participants and the identification can be biometrically confirmed, if necessary. It allows the participant to further protect any intellectual property and to further identify themselves to others to demonstrate their skills. Lastly, the confirmation can validate a participant's being present at a specific place, date and time.

In the broadest sense, the present invention and the multiple components operate like a service bureau for internet or network identity. It's a method to improve the identifiably of the participant through communications on the internet or a network, comprising software components for a company to call from its existing systems: providing a registration process for participants using their unique biometric information, creating a unique identifier based on the biometric information, and recording or embedding the unique identifier into the content of the user thereby authenticating/identifying participant. The biometric information can be DNA, retina or iris scan, fingerprint, or voice scan, or two or more of these. The participant can be a sender, authorizer, publisher, an author, a compiler, a contributor, an owner, a programmer, or distributor, or two or more of these.

### BRIEF DESCRIPTION OF THE DRAWINGS

It is to be understood that both the foregoing general description and the following detailed description present exemplary embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention, and together with the detailed description, serve to explain the principles and operations thereof. The drawings are not intended to limit the scope of the invention in any manner beyond the scope of the claims.

FIG. 1 is a text-graphic illustration of Bio-Stamp use between the participant, network interactions and the Bio-Stamp components.

FIG. 2 is a text-graphic of the Bio-Stamp Process Flow.

FIG. 3 is a text-graphic of the Registration Module.

FIG. 4 is a text-graphic of the Event Processing Module.

FIG. 5 is a text-graphic of the Setup Module.

FIG. 6 is a text-graphic of the Reveal Module.

### DESCRIPTION OF THE PREFERRED EMBODIMENTS

The present invention consists of the participant voluntarily registering his/her unique biometric information in such a way that a unique identifier is created, such as a hash number, that is unique to the participant. Participant interacts with a company or user of the Bio-Stamp invention to optionally authenticate any network event by participant. The network event may be, for example, the use by participant of a user or company's records or digital files such as emails, retail purchases, financial transactions, social networking, and the like. The invention requires a biometric scanning device to permit a participant to register biometrics that are unique to such a person such as an iris scan, a fingerprint scan, a voice print, DNA, etc. The database/domain software then creates a unique identifier for the participant. The unique identifier resides on the Bio-Stamp database.

It is envisioned that Bio-Stamp may be employed in a financial transaction such as transferring money or paying for an internet purchase; or verify participant being present at a specific place, time and date, such as verify receipt of important documents, or receipt of delivery of a package (Fed-Ex), or verify participant's presence in house arrest to the judicial system, or verify participant's identity before being allowed access to a file (such as a child's MySpace® file to prevent pedophiles from gaining access to such a file or a bank account file), or a “virtual room” of confidential documents (when conducting due diligence, or conducting a divestiture or merger), or access to a building, or preventing the purchase of items not suitable for children on Ebay, or prohibiting criminals from purchasing guns, or any situation where verification/authentification of identity is necessary, useful or valuable.

A “user” is defined as a company, person or machine that is requesting or requiring the identity of a participant be verified. Thus a user may be a company like Ebay, a bank, or car dealership, or another individual, or a computer of a company or individual. The user incorporates Bio-Stamp into its network or internet, as is explained later.

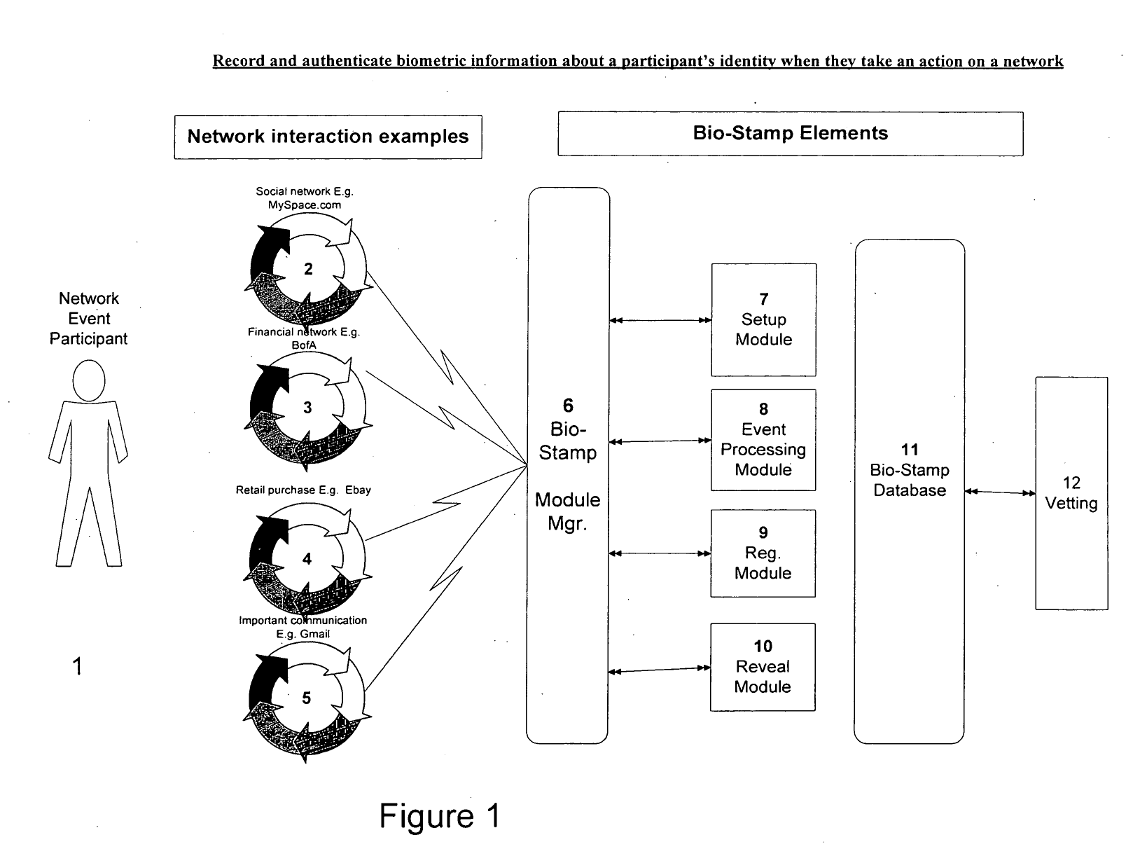

As illustrated in FIG. 1, reference numeral 1 indicates in graphical form a network or internet participant. The network participant is shown as representing a human, however, it could also be a machine, i.e., a computer requesting information from a user. When the network participant desires to use the internet for a network interaction, it may be on a social network such as MySpace® indicated by reference numeral 2, a financial network such as Bank of America indicated by reference numeral 3, a retail purchase on Ebay® indicated by reference numeral 4, or email indicated by reference numeral 5. Each of these network interactions may require Bio-Stamp to affirm who the participant is, or the participant will want each of these network interactions to verify from Bio-Stamp who he or she or it (in the case of a machine) is. Accordingly, the participant 1 can use any of the network interactions and proceed from there to the company's or user's digital files that employ Bio-Stamp.

If the network participant has already registered under the Bio-Stamp program, then any of the network interactions that desire the information of participant can seek such information from the Bio-Stamp manager module 6 and readily obtain it. On the other hand, if the participant has not registered with Bio-Stamp previously, and the network interactions 2-5, for example, desire to have participant authenticated, then the participant 1 can proceed to the Bio-Stamp module manager 6 and register himself, herself, or itself. Of course, if the network participant 1 is a machine, a responsible person who, for example, is in control of the machine, will be the party who registers as and for the machine (of a company), just as an individual human participant would register. Optionally the company or user may allow the participant to interact with its records or digital files without immediate verification, as explained hereinafter.

Reference numeral 6, identifying the module manager for Bio-Stamp, interacts with four modules, namely: setup module 7, event processing module 8, registration module 9, and reveal module 10. These four modules will be discussed in detail hereinafter. Additionally, the Bio-Stamp module manager 6 is also in communication with the Bio-Stamp database 11. This is the database where information on a network participant 1 is or will be stored. Database 11 is vetted on a regular basis as represented by numeral 12. Vetting the data base 11 may include, for example, sending a letter to participant's address, making a phone call to participant, sending an email to participant, and otherwise seeking further verification of the info supplied by the participant upon registration.

To summarize FIG. 1, a network participant 1 seeks to obtain the benefits of a network interaction with MySpace 2, Bank of America 3, Ebay 4, or email communication 5, for example. In the use of those network interactions, the network participant or the user (a company, for example) may want to verify the individual participant or the individual participant may wish to have his or her or its verification acknowledged to assure the user it is interacting with an identifiable party. That verification process involves Bio-Stamp and communication with the module manager 6 and the database 11.

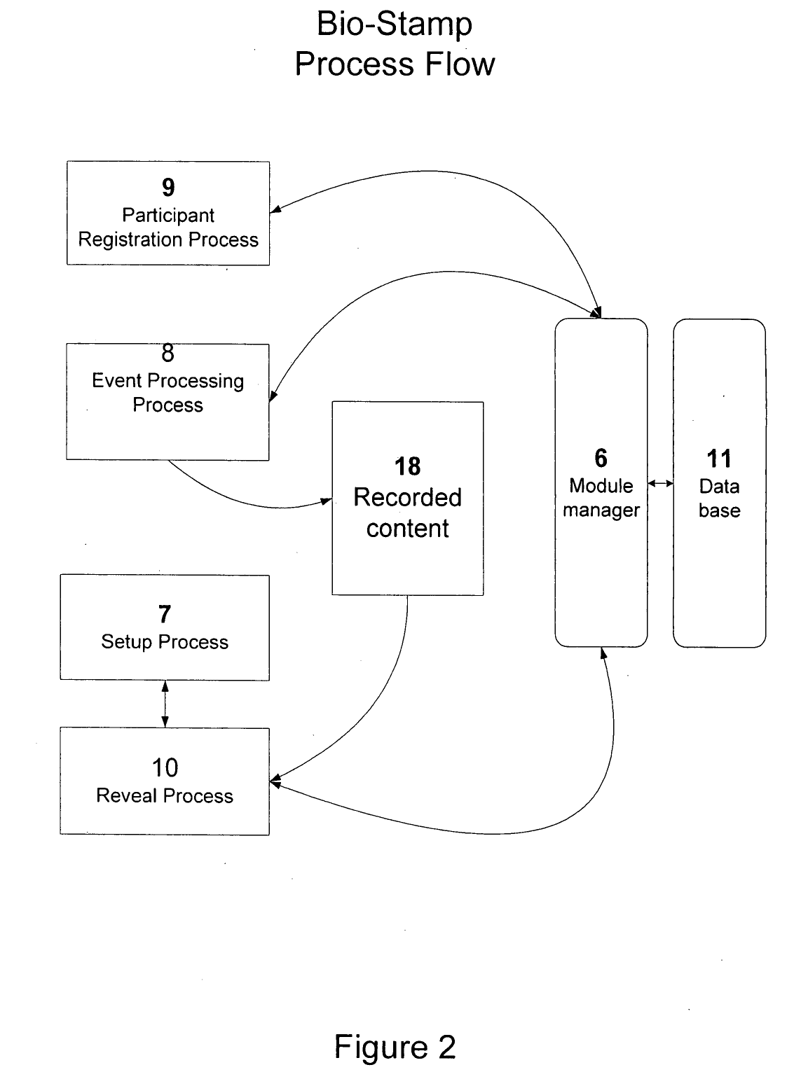

FIG. 2 illustrates the Bio-Stamp flow process. There are, relative to FIG. 2, steps for a network participant and also steps for a company network that wish to verify participant's information, or a participant who wants the user (company) to know and verify participant (such as a bank customer wanting the bank to know who is requesting a transaction from the bank). Each of those processes is a transaction in the Bio-Stamp flow process so the participant in the Bio-Stamp flow process can participate in the registration module 9 and in the event process module (recording) 8. On the other hand, a company network such as those on the network interaction listing in FIG. 1, reference numerals 2-5, can interact with the Bio-Stamp process by the setup module 7 and the reveal module 10.

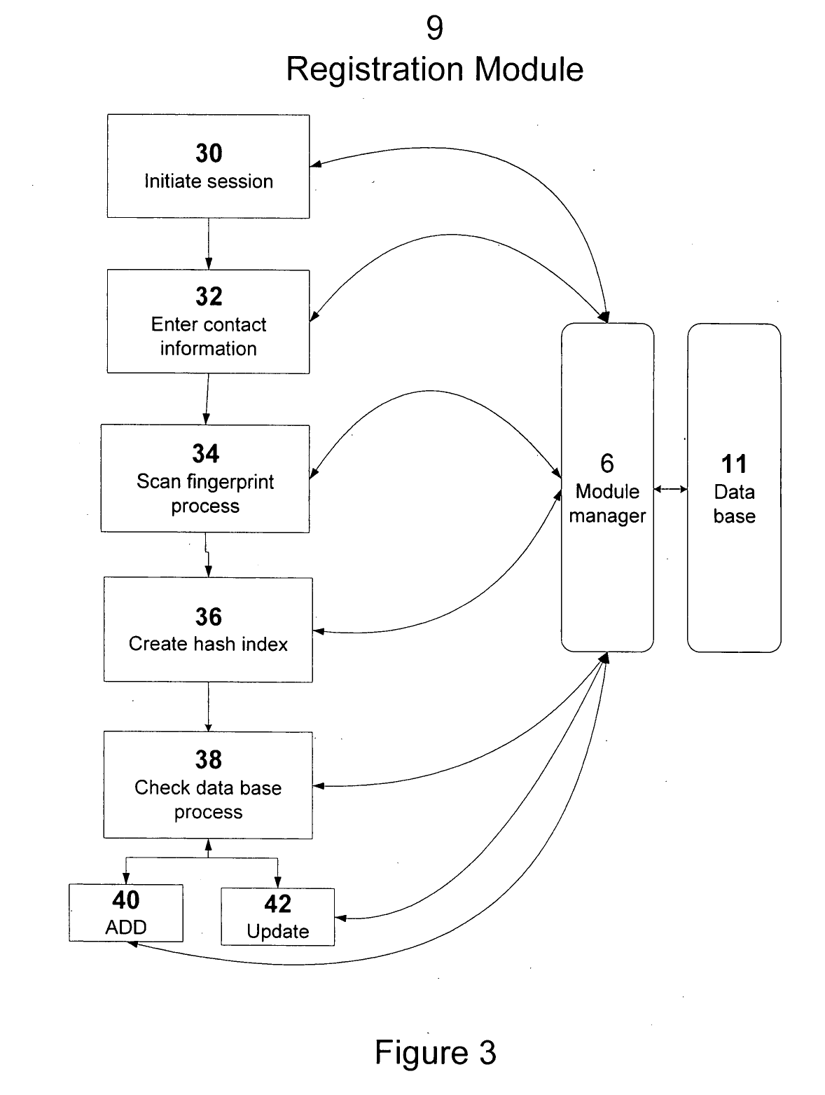

As shown in FIG. 2, the network participant interacts with the registration module 9 by communicating with Bio-Stamp and providing the necessary information as further explained with reference to FIG. 3. Once that process is completed, the network participant 1 may also interact with the Bio-Stamp process by having content recorded. For example, content such as email or financial transactions or verification of an Ebay purchase, can be useful in reconstructing the participants network events across multiple companies. The recording module 8 likewise, as illustrated in FIG. 2, interacts with Bio-Stamp, which interacts with the database 11 and records the content as illustrated by reference numeral 18.

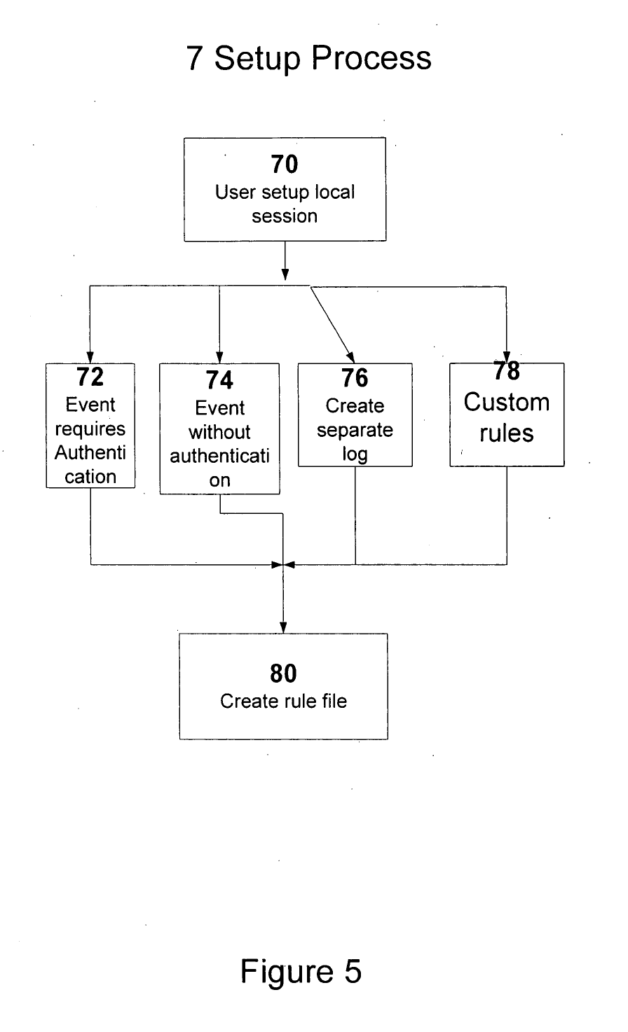

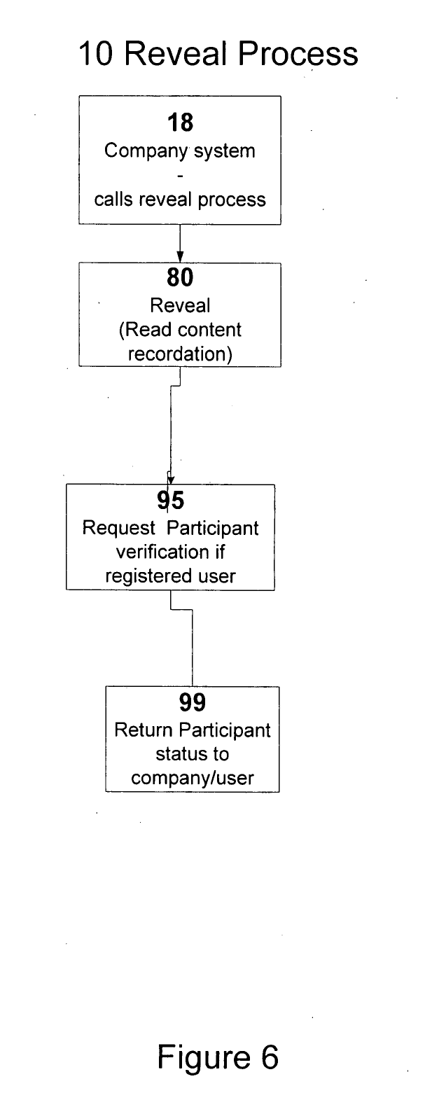

On the company or user side of the Bio-Stamp flow process, the setup module 7 allows the company to define their preferred use of Bio-Stamp process flow. For example, the company may elect only to record the network participants who are registered without wanting to know, at that time, any additional information but verify later. The various setup process modules are further explained with respect to FIG. 5. The setup module 7 interacts with the module manager 6 and the database 11 to provide the company with various flow options and selections. Lastly, the reveal module 10 also allows the company to seek authentication concerning the network participant 1 at a later point in time from Bio-Stamp via the database 11. This is also illustrated and described with respect to FIG. 6.

FIG. 3 indicates the Bio-Stamp registration module. When a network participant 1 desires to use a company's Bio-Stamp process, the network participant may choose to register before using Bio-Stamp. Under certain circumstances a participant can record his/her biometric information, obtain a unique identifier, and later could register. Again, this registration may be because the company/user network interaction demands that the participant register with the Bio-Stamp program, or the company/user may wish to have a participants identity verified by the Bio-Stamp program in order to obtain sensitive and secure information from the network interaction, for example. Therefore, a network participant 1 would contact the company/user, which company user employs of Bio-Stamp within its network, and initiate an internet session 30 via the registration module 9 to register the network participant's information. The registration module 9 will require the network participant 1 to enter specific information which is designated in FIG. 3 by reference numeral 32. The information would include the name, address, phone number, perhaps email address, etc. of the network participant 1.

As shown in FIG. 3, the registration module always requires the biometric information to create the unique identifier as represented by reference numeral 34, as requiring a fingerprint of the network participant. The fingerprint is scanned into the network participant's computer, for example, by using a fingerprint scanner, and that information is sent back to the module manager 6. As stated previously, the biometric fingerprint information 34 may be DNA information, a retina scan or iris scan, voice scan or two or more of these. For illustration purposes, FIG. 3 shows the biometric information being obtained and illustrated graphically as reference numeral 34. However, it is obvious that the other types of unique biometric information can be employed.

Next, a unique hash index 36 is created that can include various symbols, such as letters, or other symbols, or it could be all symbols and no numbers, or all numbers. Nevertheless, the hash index would be a unique number, or symbols, or the combination thereof that would be unique to the network participant based upon the network participant's biometric information. This information is or will be stored in the database 11.

The registration module may also be checked from time to time by a network participant to assure that the information in the Bio-Stamp database 11, such as the contact information 32, the biometric information 34 and/or the hash index 36 are not in need of amendment. This process of checking the database is graphically illustrated by reference numeral 38. The network participant 1 would ask the module manager 6 for his or her information, after first scanning in the biometric information and allowing Bio-Stamp to re-create the hash index, note that it is already contained in the Bio-Stamp database, and making participant's information available to participant. This assures the network participant if his or her information was accurately recorded and previously registered. If the information is acceptable in the form that it was previously added, as indicated by 40, then the network participant 1 informs the Bio-Stamp that all information is current information and step 40 adds the current information to database 11 On the other hand, should the network participant need to amend any of the information, such as the network participant's contact information where he or she has recently moved, this updated information 42 can be supplied to Bio-Stamp. While the module manager 6 performs all of the functions of assuring the sought-after information is adequate, the actual information itself for each and every network participant is stored in the database 11. Optionally, the Bio-Stamp database 11 may be sufficiently large to store the scanned image of the biometric information along with the hash index and contact information.

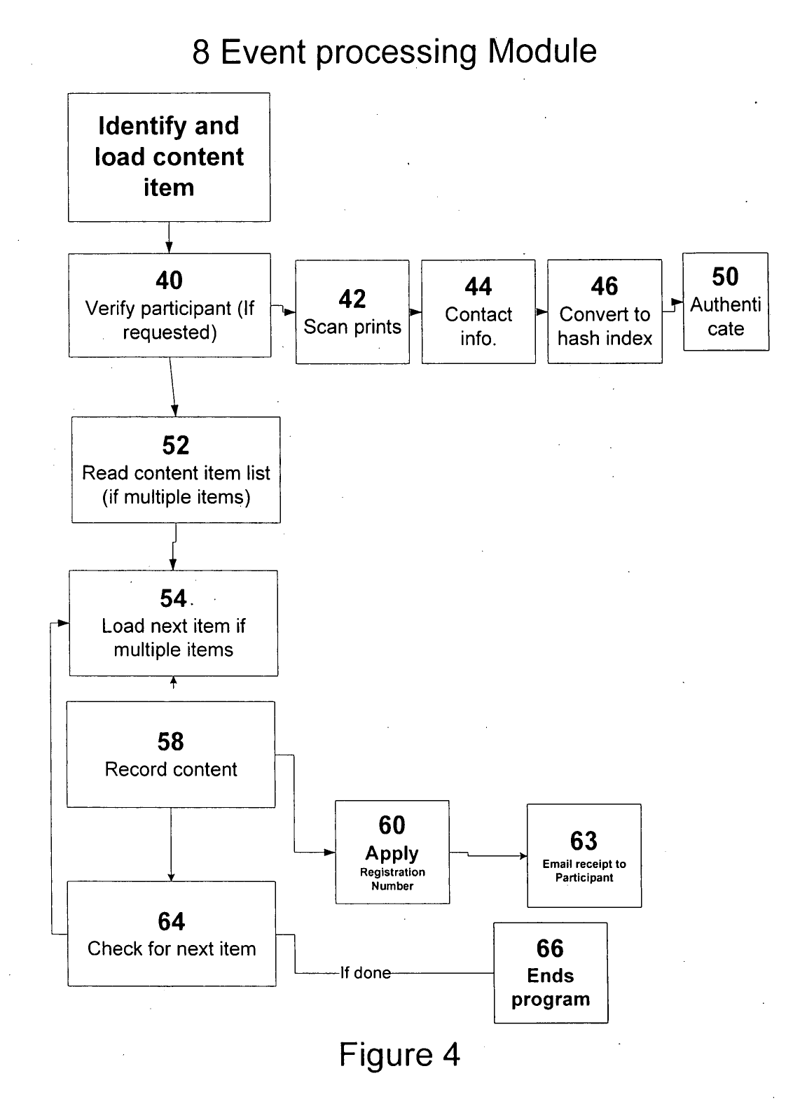

The next module a network participant may encounter would be the event processing module (recording) 8. When a participant desires to use a company's network that is linked with Bio-Stamp to accomplish events or actions desired by the participant the event processing module 8 is employed as illustrated in FIG. 4.

The participant uses the software or program of a user (Ebay®, for example) that is linked with Bio-Stamp and loads the user's content item on the computer used by participant. For example, this may be or take the form of a financial network such as desiring to transfer money from one account to another entity's account, or to bid or pay for a purchase on Ebay, or to verify confidential communication. The particular form of the content can be virtually any user's/company's record or digital file such as their software programs, websites, email, files (PDF, TIF, GIF, JPEG), games, drawings, pictures, video clips, audio clips, email messages, movies, music, songs, transactional directives, or any document of any type, where it is desirable for either the network participant to verify who he or she is, or for the company to request the user to verify who he or she is.

Once the user's content item has been displayed on the participant's computer, Bio-Stamp would ask the network participant to scan their fingerprint (or their biometric information). Depending upon the user's setup, the user may require participant to be registered, or user may record the event and registration can optionally be accomplished in the future (with later verification) as previously described in FIG. 3. On the other hand, if the participant has previously registered in the Bio-Stamp database (regardless of company/user), participant would scan their biometric information, Bio-Stamp would create the same unique identifier 46 (see FIG. 4), compare that with what is in the database 11, and authenticate 50 the participant. Optionally the database may also request the contact information 44 as a precaution. The user/company may read the participant's status record to potentially find that participant was flagged by another company, and hence refuse authentication or access. Once the network participant has been authenticated, the module manager is now in a position to determine how many content items need to be recorded by the user (for example Ebay may have received many bids from a single participant, and needs to authenticate the bids of participant), i.e. scan once and record multiple elements. Thus the user can provide the Bio-Stamp with a list of multiple items if there are multiple items to be recorded, as illustrated by reference numeral 52. Next, the loaded item is presented to Bio-Stamp as represented by reference numeral 54 and the module manager 6 records the loaded item as represented by box 58. If multiple items are in need of the recording process, the Bio-Stamp module manager 6 will refer to the list 52 and determine what is the next item on the list, if any, as represented by reference numeral 64. If there are still items remaining to be recorded, then steps 54, 58 and 64 are repeated. The recording process represented by reference numeral 58 not only applies the hash index to the content as represented by reference numeral 60, but Bio-Stamp also lets the participant 1 know through an email receipt 63 to participant that an identified content item has been recorded. Once all of the items have been recorded, Bio-Stamp then ends the program of the recording module as represented by reference numeral 66.

The disclosure of the setup module 7 and the reveal module 10 are, as stated previously, primarily for user/company verification purposes so that the company such as MySpace®, or Bank of America, or Ebay®, can verify that the network participant 1 is who they say they are. First, the setup module 7 is illustrated in FIGS. 1 and 5. The setup module permits a company to set up its preferences, for example, to indicate to the module manager 6 the process flow preferences desired. The first preference would be choosing to accept only internet interactions which can be and are immediately authenticated and the participant must be registered or can register on the fly, as represented by reference numeral 72. The second choice is to accept a participant that may not be registered, but seek verification/authentication at a later point in time as represented by numeral 74. So, 72 and 74 are mutually exclusive in that the company chooses between these possibilities for a given use of Bio-stamp. Next, reference numeral 76 can create an optional log where Bio-Stamp creates and maintains an event log for user, of each participant's interaction with it, such as date, time, and type of event. Optionally the corporation may have some custom rules 78 such as determining exactly what information the company wishes to record or reveal from the Bio-Stamp. For example, the company may wish to accept all communication for Bio-Stamp registrants who are participants, but instead of accepting or verifying their information, the corporation would just like to have their name or perhaps their hash index or perhaps a combination of such information. A user's rules can also require links to a company user list with permissions. Once a corporation has selected the various process module selections, then a user rule file 80 is created such that every time the corporation logs onto the Bio-Stamp module manager 6, the rule file informs the module manager what preferences the company has selected.

Lastly, the corporation may activate the reveal module 10 through the Bio-Stamp module manager 6. The reveal process module is illustrated in FIG. 6.

When the reveal module is activated as illustrated by reference numeral 18 in FIG. 6, the Bio-Stamp module manager 6 reads the record of the content item desired to be verified or revealed by a user (Ebay) as to the participant's information as indicated by reference numeral 80. Once the module manager 6 reads the Bio-Stamp information in the item content, it verifies the participant 1 by checking with the database to see whom the participant is, and extracts the information from the database concerning the network participant 1. Then the module manager 6 provides the corporation with participant's information including their status. For example, if Ebay desired the information, the reveal module through the module manager 6 would inform Ebay who the network participant 1 is that seeks to have his or her identity verified. Should the user have a problem with participant's information, the user may inform Bio-Stamp of the problem and Bio-Stamp can “red-flag” the participant, and place an appropriate comment on the status of participant, such as “contact information is no longer valid”. These status messages can then be shown to other users/companies, to warn them of participant's incorrect information. Furthermore, if Bio-Stamp has also preserved a scanned image of participant's biometric information, this can be forwarded to the police or a like agency, if a crime has been committed.

A given participant's events can be reconstructed from the event processing, logging and the Bio-Stamp database. The reconstruction can reach across multiple companies/users to provide a broad view of the participant's events. By example, the participant utilized several different companies services and products over a given period of time (all being Bio-Stamp users). The event processing, logs and database can provide a consistent thread through all the companies used by participant thus allowing for a reconstruction or retracing of a participants events over time.

Thus it is apparent that there has been provided, in accordance with the invention, a method that fully satisfies the objects, aims, and advantages set forth in the description. While the invention has been described in conjunction with specific embodiments, it is evident that many alternatives, modifications and variations fall within the spirit and broad scope of the invention and claims.

What is claimed is:

1) A method to improve the integrity of computer network communications, comprising: providing a registration process for participants, said registration process having unique biometric information and other personal information of said participant; storing said biometric information and other personal information in a database, including a unique identifier derived from said biometric information; embedding said unique identifier into a document of a network event; recording and revealing upon request by a user, selective biometric and/or personal information about said participant, to document, verify and reveal participant's identity; optionally creating a receipt (history log) for said user of said network event and verification of said participant.

2) The method of claim 1, wherein said step of storing and said step of recording and revealing occurs by employing said unique identifier to obtain said information from said database.

3) The method of claim 1, wherein said biometric information can be DNA, retina or iris scan, fingerprint, voice scan, or two or more of these.

4) The method of claim 1, wherein said network event comprises at least one of: message, email, transactional directive, file, document, website, software, drawing, picture, video clip, audio content, movie, music, song, game or any other content item sent, received or posted on a network.

5) The method of claim 1, wherein said participant comprises a person seeking entry or access, a sender, a receiver, an authorizer, a publisher, a compiler, an author, a creator, a contributor, an owner, a programmer, a distributor, or two or more of these.

6) The method of claim 1, wherein a user is a licensee, requester, a customer, a receiver, a company, a reviewer, an operator of a business, a human or a machine.

7) The method of claim 1, wherein said network event can comprise, among other activities: entering a building, signing on to a system, initiating a financial transaction, receiving goods or services such as a high-value automobile, sending an e-mail, posting content on the internet, reviewing posted content on the internet, validating ownership of intellectual property in a digital format, or confirming a participant being present at a specific location and a specific date and time.

8) The method of claim 1, wherein recording and revealing to the user upon request of a user is comprised of either recording said unique identifier, if not fully registered; or recording and revealing, if already fully registered; or only revealing, if request is after the initial network event.

9) The method of claim 1, wherein said unique identifier can be a hash number, letters, symbols, or a combination of two or more of letters, numbers, and symbols.

10) The method of claim 1, wherein said recording provides said participant with notification of said user's recording request.

11) The method of claim 1, wherein said stamp (marker) is provided and can contain information which may include biometric information, personal information and a unique identifier all related to the participant and, as a form of receipt, can also document (record) a network event and facilitate post event access to such information on the database.

12) The method of claim 1, wherein said step of embedding includes incorporating said unique identifier and optional specific information into said content in a subroutine program in said content such that it is normally not visible or does not normally interfere with the function or purpose of the content.

13) The method of claim 1, wherein said step of embedding includes a listing program in said data base that can read the number of contents items desired to be recorded.

14) The method of claim 13, wherein said listing program loads the next content item on said list, if any, such that said embedding step can be executed on said next item, until all items are recorded.

15) The method of claim 1, further comprising a reveal program comprising the step of revealing if said content has a Bio-Stamp, and reveal the details of said specific event information such as but not limited to, the participants unique Bio-stamp identifier.

16) The method of claim 15, wherein said reveal program further includes the step of creating, for a user, a setup file to specify the user's preferences on content.

17) The method of claim 1, wherein participant's record status can be flagged with messages that further authenticate a participant to other companies using the Bio-stamp process.

18) The method of claim 1, wherein a given participant's events can be reconstructed from the event processing, logging and the Bio-Stamp database.

19) The method in claim 18 wherein the reconstruction can reach across multiple companies/users to provide a broad view of the participant's events.

20) The method in claim 1 wherein the participant can register while using one company's service or products and then said registration is usable for authentication by all other user/companies of bio-stamp
